(19) United States
(12) Patent Application Publication
(10) Pub. No.: US 2023/0088842 A1
(43) Pub. Date: Mar. 23, 2023

(54) COMPOSITE ANODE FOR LITHIUM SECONDARY BATTERY AND METHOD OF MANUFACTURING THE SAME

(71) Applicants: Hyundai Motor Company, Seoul (KR); Kia Corporation, Seoul (KR)

(72) Inventors: Jesik Park, Seoul (KR); Sangheon Lee, Yongin, Gyeonggi-do (KR); A Reum Ha, Ulsan (KR); Jeong Hyun Seo, Daejeon (KR); Ju Yeong Seong, Suwon, Gyeonggi-do (KR); Sung Woo Noh, Seoul (KR)

(21) Appl. No.: 17/943,666

(22) Filed: Sep. 13, 2022

(30) Foreign Application Priority Data
Sep. 13, 2021 (KR) 10-2021-0121642

(51) Int. Cl. H01M 4/40; H01M 10/0568; H01M 10/0569; H01M 4/04; H01M 4/62; H01M 10/0525

(52) U.S. Cl. CPC H01M 4/405; H01M 10/0568; H01M 10/0569; H01M 4/045; H01M 4/625; H01M 10/0525; H01M 2004/027

(57) ABSTRACT

Disclosed herein is a composite anode for a lithium secondary battery and a method of manufacturing the same. The composite anode for a lithium secondary battery where a lithium metal or a lithium metal composite is uniformly distributed and located may be manufactured using a simple pulse-electrodepositing method while minimizing an amount of lithium to be used. Moreover, a dendrite growth of lithium may be suppressed during charging because the lithium metal or the lithium metal composite is uniformly located on the porous conductor.

### CROSS-REFERENCE TO RELATED APPLICATION

This application claims under 35 U.S.C. § 119(a) the benefit of priority to Korean Patent Application No. 10-2021-0121642 filed on Sep. 13, 2021, the entire contents of which are incorporated herein by reference.

### TECHNICAL FIELD

The present invention relates to a composite anode for a lithium secondary battery and a method of manufacturing the same.

### BACKGROUND

With the development of information communication industries, making electronic devices small, light, thin, and portable is required, and thus a demand for high energy density of a lithium secondary battery used as a power source of this electronic device becomes higher.

The lithium secondary battery, and particularly, a lithium ion battery (LIB) is a battery mostly suitable to this demand, and has been adopted as a power source for many portable devices due to high energy density and an easy design.

As a use range of the lithium secondary battery has been recently expanded from small electronic devices in the past to large electronic devices, automobiles, smart grids, and so on, a lithium secondary battery capable of maintaining excellent performance at room temperature as well as a high temperature, or even in an severer external environment such as a low-temperature environment has been requested.

Particularly, lithium used in the lithium secondary battery is a material having a lowest electromotive force among the elements, and is used for an anode for the lithium secondary battery, so that it is possible to expect a battery having high energy density.

However, in the case of an anode using a lithium metal, when a lithium foil is used as the anode, lithium is sometimes precipitated on a surface of the anode in a dendrite shape during charging. When the formed dendrite comes into contact with a cathode, an internal short circuit may occur and thus it is very dangerous. In addition, repetition of charging and discharging causes the dendrite to come off from the surface of the anode, so that lithium particulates that cannot be used for charging and discharging are produced to reduce a charging/discharging capacity. For this reason, there is difficulty in producing a secondary battery having a long charging/discharging cycle life span.

In addition, a conventional type of producing an anode from slurry formed of lithium powder has an explosion problem caused by high reactivity of lithium powder, a problem caused by a great particle size distribution difference of the lithium powder, and a problem with an expensive maintenance expense because a reactor should be maintained at a high temperature for a long time.

### SUMMARY

In preferred aspects, provided is a method of manufacturing a composite anode for a lithium secondary battery, which applies a voltage or a current on a specific condition and performs pulse-electrodeposition of a lithium metal on a porous conductor. Also provided is a composite anode for a lithium secondary battery, which includes a porous conductor, and a lithium metal or a lithium metal composite that is uniformly located on the porous conductor at a specific content in a specific size.

Objectives of the present invention are not limited to the above-described objectives. The objectives of the present invention will be apparently understood by the following description, and can be implemented by means described in the appended claims and a combination thereof.

In an aspect, provided is method of manufacturing a composite anode for a lithium secondary battery. The method includes: preparing an electrolyte including a lithium salt and a solvent; disposing a working electrode including a porous conductor and a counter electrode including a lithium metal in the electrolyte; and applying a voltage or a current through a power supply connected to the working and counter electrodes to perform pulse electrodeposition of the lithium metal on the porous conductor.

The lithium salt may include one or more selected from the group consisting of LiPF₆, LiBF₄, LiTFSI, LiClO₄, LiTf, LiAsF₆, LiFSA, LiBOB, LiDFOB, LiBETI, LiDCTA, LiTDI, LiPDI, LiI, LiF, and LiCl.

The solvent may include one or more selected from an organic solvent and an ionic liquid.

A concentration of the lithium salt in the electrolyte may be from about 0.05 M to about 2 M.

The porous conductor may include one or more selected from the group consisting of a carbon nanotube, a carbon felt, carbon paper, and a carbon fiber.

When the pulse electrodeposition is performed, the voltage may be applied by a higher value than an absolute value of a lithium reduction potential by about 1.0 V to 2.0 V.

When the pulse electrodeposition is performed, the number of pulse frequencies may range from about 50 to about 2000.

When the pulse electrodeposition is performed, a pulse time may range from 10 ms to 1000 ms.

When the pulse electrodeposition is performed, a working temperature may be equal to or less than about 200° C.

The method may further include plating a lithium alloy on the porous conductor.

The lithium alloy may include i) lithium (Li), and ii) one or more selected from the group consisting of gold (Au), silver (Ag), tin (Sn), copper (Cu), aluminum (Al), magnesium (Mg), nickel (Ni), titanium (Ti), silicon (Si), and antimony (Sb).

When the pulse electrodeposition is performed, the lithium metal may be pulse-electrodeposited on the lithium alloy.

The method may further include surface-modifying the pulse-electrodeposited result.

In an aspect, provided is a composite anode for a lithium secondary battery that includes: a porous conductor; and a lithium metal located uniformly on the porous conductor.

A content of the lithium metal may be from about 0.05 wt % to about 30 wt % on the basis of the entire composite anode of 100 wt %.

The lithium metal may have a size of about 5 nm to 100 nm.

In an aspect, provided is a composite anode for a lithium secondary battery that includes: a porous conductor; and a lithium metal composite located uniformly on the porous conductor, wherein the lithium metal composite includes a lithium metal on a lithium alloy.

The lithium alloy may include i) lithium (Li), and ii) one or more selected from the group consisting of gold (Au), silver (Ag), tin (Sn), copper (Cu), aluminum (Al), magnesium (Mg), nickel (Ni), titanium (Ti), silicon (Si), and antimony (Sb).

The lithium metal composite may have a size of about 10 μm to 200 μm.

The method of manufacturing a composite anode according to various exemplary embodiments of the present invention can manufacture the composite anode for a lithium secondary battery such that a lithium metal or a lithium metal composite is uniformly distributed or located using a simple pulse electrodeposition method while minimizing an amount of use of lithium, and thus has an advantage in that economy is excellent, for example that manufacturing processes are considerably reduced.

Further, the composite anode for a lithium secondary battery manufactured by a manufacturing method according to various exemplary embodiments of the present invention has an advantage in that a dendrite growth of lithium during charging can be suppressed because a lithium metal or a lithium metal composite is uniformly located on a porous conductor.

The effects of the present invention are not restricted by the effects mentioned above. It will be understood that the effects of the present invention include all the effects that can be inferred from the following description.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a sectional view and an enlarged view illustrating a composite anode for a lithium secondary battery in which a lithium metal is included according to the present invention;

FIG. 2 is a sectional view and an enlarged view illustrating a composite anode for a lithium secondary battery in which a lithium metal composite is included according to the present invention;

FIG. 3 shows an exemplary FE-SEM image of a surface of an exemplary composite anode for a lithium secondary battery (including a lithium metal composite) which is manufactured according to Example 1;

FIG. 4 shows a result of controlling lithium particles according to a pulse level of the composite anode for a lithium secondary battery (including a lithium metal composite) which is manufactured according to Example 1;

FIG. 5 shows a charging and discharging graph of an all-solid-state battery according to Example 1, Comparative Example 1, and Comparative Example 2;

FIG. 6 shows a graph illustrating a result of evaluating cycle characteristics of an all-solid-state battery according to Example 1, Comparative Example 1, and Comparative Example 2; and FIGS. 7A to 7C are graphs illustrating results of evaluating cycle characteristics of the all-solid-state battery according to Example 1 (FIG. 7A), Comparative Example 1 (FIG. 7B), and Comparative Example 2 (FIG. 7C).

### DETAILED DESCRIPTION

Objectives, other objectives, features, and advantages of the present invention will be easily understood through the following preferred embodiments associated with the accompanying drawings. The present invention may, however, be embodied in different forms and should not be limited to the embodiments set forth herein. Rather, these embodiments introduced herein are provided so that the disclosed contents will be thorough and complete and will convey the idea of the present invention to those skilled in the art.

In describing each drawing, like reference numerals are used for like components. In the accompanying drawings, the dimensions of structures are illustrated in an enlarged scale compared to the reality for clarity of the present invention. Although terms such as a first a second, and so on are used to describe various components, the components should not be limited by these terms. These terms are used only to differentiate one component from another one. For example, without departing from the scope of right of the present invention, a first component may be termed a second component, and similarly, the second component may also be termed the first component. As used herein, the singular forms are intended to include the plural forms unless the context clearly indicates otherwise.

Herein, it should be understood that the term such as “include”, “comprise”, “including”, “comprising”, “have”, or “having” designates a characteristic, a number, a step, a process, a component, a part, or a combination thereof, but does not previously exclude the presence of or the possibility of adding one or more other characteristics, numbers, steps, processes, components, parts, or combinations thereof. It will also be understood that; when a portion such as a layer, a film, a region, or a substrate is referred to as being “on” another portion, this includes the case where the portion is directly on the other portion as well as the case where another portion is present on one or more intervening portions. To the contrary, when a portion such as a layer, a film, a region, or a substrate is referred to as being “under” another portion, this includes the case where the portion is “directly under” the other portion as well as the case where another portion is present on one or more intervening portions.

Unless not stated otherwise, all figures, values, and/or expressions that express components, reaction conditions, and amounts of polymer compositions and blends used herein are approximate values on which various uncertainties of measurement which are generated in obtaining these values are reflected among these figures which are essentially different from one another, and thus should be understood to be modified by a term called “about” in all cases. Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Also, in a case in which a numerical range is disclosed herein, this range is continuous, and includes all values from a minimum value of this range to the maximum value including a maximum value unless not designated otherwise. Furthermore, in a case in which this range indicates an integer, all integers from the minimum value to the maximum value including a maximum value unless not designated otherwise are included.

In a case in which a range is described for a variable in this specification, it will be understood that the variable includes all values within the described range including end points described in the range. For example, it will be understood that a range of “5 to 10” includes values of 5, 6, 7, 8, 9, and 10 as well as an arbitrary subordinate range of 6 to 10, 7 to 10, 6 to 9, 7 to 9, and so on, and also includes an arbitrary value between integers appropriate to a category of a described range such as 5.5, 6.5, 7.5, 5.5 to 8.5, and 6.5 to 9. For example, it will be understood that a range of “10% to 30%” includes all integers including values such as 10%, 11%, 12%, and 13% and up to 30% as well as an arbitrary subordinate range such as 10% to 15%, 12% to 18%, and 20% to 30%, and also includes an arbitrary value between appropriate integers within a described range such as 10.5%, 15.5%, and 25.5%.

conventionally, in a case in which lithium used in a lithium secondary battery is used in an anode in a form of a lithium foil, there is a problem that a manufacturing expense becomes expensive because a large amount of lithium is used, there is problem that dendrite is grown and precipitated on a surface of the anode during charging, and there is a problem in that the lithium repeats plating and stripping while charging and discharging are in progress, so that a contact surface with a current collector is reduced, and moving passages of electrons are reduced to accelerate the dendrite growth of the lithium while causing non-uniform current distribution. For this reason, the growth, and the contact of the dendrite whose growth is accelerated with a cathode are responsible for an internal short-circuit, which is very dangerous. In addition, there is a problem that, when the charging and the discharging are repeated, this generates particulate lithium that is separated from an anode surface and cannot be used for charging and discharging, thereby reducing charging/discharging capacity.

In addition, a conventional type of manufacturing an anode using slurry made of lithium powder has a problem of explosion due to high reactivity of the lithium powder, a problem of a great particle size distribution difference of the lithium powder, and a problem of an expensive maintenance expense because a reactor should be maintained at a high temperature for a long time.

Thus, as a result of the inventors of the present invention making an intensive study to resolve the above problems, the inventors discover that, in a case of manufacturing a composite anode for a lithium secondary battery by a manufacturing method of pulse electrodepositing a lithium metal on a porous conductor by applying a voltage or a current on a specific condition, a dendrite growth of lithium can be greatly suppressed by including the porous conductor, and a lithium metal or a lithium metal composite located uniformly on the porous conductor at specific content in a specific size, and complete the present invention.

In an aspect, provided is a method of manufacturing a composite anode for a lithium secondary battery includes a step S10 of preparing an electrolyte with a lithium salt and a solvent, a step S20 of disposing a working electrode including a porous conductor and a counter electrode including a lithium metal in the electrolyte; and a step S30 of applying a voltage or a current through a power supply connected to the working and counter electrodes to pulse electrodeposit the lithium metal on the porous conductor.

A term “pulse electrodeposition” as used herein refers to applying a pulse voltage or current through the power supply connected to the working and counter electrodes for a fixed time in the periodic number of times, and electrodepositing the lithium metal on the working electrode including the porous conductor through an electrolysis.

The step S10 of preparing an electrolyte is a step of preparing an electrolyte used in the electrolysis for the pulse electrodeposition.

The electrolyte may include the lithium salt and the solvent.

The lithium salt is not particularly limited and a salt that allows lithium ions to move through the electrolysis for the pulse electrodeposition may be used without limitation. The lithium salt may include one or more selected from the group consisting of, for example, LiPF₆, LiBF₄, LiTFSI, LiClO₄, LiTf, LiAsF₆, LiFSA, LiBOB, LiDFOB, LiBETI, LiDCTA, LiTDI, LiPDI, LiI, LiF, and LiCl, and is not limited by including only a specific component.

The solvent is not particularly limited and a material that can solve the lithium salt may be used without limitation. The salt may particularly include one or more selected from an organic solvent and an ionic liquid. For example, the organic solvent may include one or more selected from the group consisting of PC, EC, DME, DEC, DMC, FEC, DOL, DMI, DMSO, TEGDME, EEE, PEGDME, and DEGDME, and is not limited as including only a specific component. Further, the ionic liquid may include one or more selected from a combination of one or more cations selected from the group consisting of EMIM, BMIM, PP13, Py14, DEME, and DMPI and one or more anions selected from the group consisting of FSA, TFSI, BF₄, PF₆, Cl, Br, I, AcO, AlCl₄, and EtSO₄, and is not limited as including only a specific component.

A concentration of the lithium salt can be properly adjusted as the lithium ions are sufficiently supplied at the time of the pulse electrodeposition. Preferably, as a working temperature becomes high, and as viscosity of the electrolyte becomes low, the lithium salt can be used at a high concentration, and more preferably the lithium salt may be included in the electrolyte at a concentration of about 0.05 M to 2.0 M. When the concentration of the lithium salt is too low beyond the range, e.g., less than about 0.05 M, ions sufficient for nucleation and particle growth are not supplied to be able to cause non-uniform distribution and particle size. When the concentration of the lithium salt is too high, e.g., greater than about 2.0 M, there is a disadvantage in that dissolution and precipitation of the lithium salt occur or ion conductivity of the electrolyte is low, which reduces current efficiency.

The step S20 of disposing electrodes in the electrolyte may include a step of preparing and disposing the working electrode and the counter electrode acting as a two-electrode system for the pulse electrodeposition in the electrolyte prepared in the step S10.

The working electrode is an electrode which is pulse-electrodeposited in an electrolysis reaction and at which a reduction reaction occurs. The working electrode may be a platinum electrode, a gold electrode, a carbon electrode, a mercury electrode, a nickel electrode, or the like, and preferably the carbon electrode that includes carbons as porous conductors that have a wide specific surface area and are electrochemically stable.

The porous conductor is a conductive material including carbons, and is not particularly limited as long as it is used in the anode for the lithium secondary battery and charging and discharging of the lithium ions are possible, and may include one or more selected from the group consisting of, for example, a carbon nanotube, a carbon felt, and a carbon fiber.

The counter electrode may be an electrode that serves to receive or send a current such that a reaction of the working electrode as an auxiliary electrode can be smoothly performed and that completes an electric circuit by movement of electric charges. The counter electrode may be a carbon electrode, a nickel electrode, a steel electrode, a platinum electrode, a lithium electrode, or the like, and may preferably use the lithium electrode such that a lithium metal is reduced by the pulse electrodeposition.

The step S30 of pulse electrodepositing the lithium metal is a step of applying a voltage or a current through a power supply connected to the working electrode and the counter electrode, pulse-electrodepositing the lithium metal on the porous conductor, and manufacturing the composite anode for a lithium secondary battery.

Particularly, at the time of the pulse electrodeposition, a voltage is repetitively applied and released on a specific condition, and thereby an electrolysis condition favorable for the electrodeposition of the lithium metal can be accomplished. At this time, as a time to apply a pulse potential, a pause time, and the number of times of repetition may be adjusted, distribution and a particle size of the reduced lithium metal can be adjusted.

In particular, the voltage checked according to the constituting pulse electrodeposition system preferably applies a value higher than an absolute value of a lithium reduction potential by about 1.0 V to 2.0 V (e.g., −4.04˜−5.04 V in a case of Li⁺+e⁻→Liₘₑₜₐₗ=−3.04 V). When a voltage greater than the predetermined range, e.g., less than about 1.0 V, is applied, this does not exceed nucleation energy, and thus a sufficient amount of nuclei are not produced. When a voltage greater than the predetermined range, e.g., greater than about 2.0V, is applied, there is a disadvantage in that a density of the particles is high and irregular particles are electrodeposited.

Further, at the time of the pulse electrodeposition, a pulse time when a voltage is applied on the above condition may be about 10 ms to 1000 ms. When the pulse time deviates from this range to be too short, e.g., less than about 10 ms, an amount of lithium ions reduced from the electrode surface is small. When the pulse time is too long, e.g., greater than about 100 ms, this becomes a condition on which particle growth is favorable, and thus it is difficult to form a constant particle size.

In the pulse electrodeposition, one cycle is defined as being applied within the voltage range for the pulse time and then being paused for a time of about 0.2 to 2 times the pulse time. The number of pulse frequencies which sets one cycle to once may be 50 to about 2000, and preferably about 100 to 1000. When the number of pulse frequencies deviates from the above range and is too small, e.g., less than about 50, there is a disadvantage in that a size of the reduced lithium particle is too small. When the number of pulse frequencies is too large, e.g., greater than about 1000, there is a disadvantage in that irregular and coarse lithium of a cluster form rather than an independent particle form is deposited.

When the pulse electrodeposition is performed, a pulse temperature may be different according to the solvent of the included electrolyte. For example, in the case of a pulse system of an electrolyte produced of an organic solvent, the pulse temperature may be less than or equal to about 60° C., and preferably from about 40° C. to about 50° C. Further, in the case of a pulse system of an electrolyte produced of an ionic liquid, the pulse temperature may be less than or equal to about 200° C., and preferably from about 80° C. to about 150° C. When the pulse temperature deviates from the above range and is too low, a solubility of the lithium salt is low, and the ionic liquid electrolyte has a disadvantage in that viscosity thereof becomes high. When the pulse temperature is too high, the organic solvent has a disadvantage in that evaporation thereof occurs and the lithium salt is precipitated.

That is, at the time of the pulse electrodeposition, dispersion of the lithium metal on the porous conductor can be adjusted through adjustment of the voltage and the number of pulse frequencies. Finally, the lithium metal can be uniformly distributed on the porous conductor, and a size of the lithium metal can be properly adjusted through adjustment of the pulse time. Thus, the finally manufactured composite anode for a lithium secondary battery is characterized in that the dendrite growth thereof can be efficiently suppressed.

In addition, the present invention may include preparing a composite porous conductor in which a metal capable of being alloyed with lithium is plated on a porous conductor prior to pulse electrodeposition, and performing the pulse electrodeposition using the composite porous conductor as a working electrode. Because generated energy for forming a lithium metal at the time of the pulse electrodeposition by plating the metal on the porous conductor is reduced, the pulse electrodeposition can be efficiently performed, as well as the plated lithium alloy facilitates diffusion of the lithium on a surface thereof at the time of future charging/discharging, and thus there is an advantage in that irregular dendrite growth can be suppressed.

Particularly, the step S15 of preparing the composite porous conductor can be performed by a typical method that can be used to plate a lithium alloy on the porous conductor in the present invention, for example by a method such as electroplating, electroless plating, physical coating, and so on.

The lithium alloy used at this time may be a metal that can separate lithium metal ions and can be alloyed with a lithium metal at the time of future charging and discharging, for example an alloy metal that includes i) lithium (Li), and ii) one or more selected from the group consisting of gold (Au), silver (Ag), tin (Sn), copper (Cu), aluminum (Al), magnesium (Mg), nickel (Ni), titanium (Ti), silicon (Si), and antimony (Sb), and is not limited to a specific metal only.

Next, the pulse electrodeposition is performed in the same way as the above step, so that the lithium metal is pulse-electrodeposited on the lithium alloy by the pulse electrodeposition. Finally, a composite anode for a lithium secondary battery including the lithium metal composite uniformly located on the porous conductor including the lithium metal on the lithium alloy can be produced.

Further, the method of manufacturing a composite anode for a lithium secondary battery according to the present invention may further include a step S40 of additionally surface-modifying the pulse-electrodeposited result.

The surface-modifying method is not particularly restricted in the case of a method capable of improving wettability on a surface of the pulse-electrodeposited result, and may perform surface modification using, for instance, a method such as a nitrogen doping method.

If the wettability is improved on the surface of the result through the surface modification, movement of the lithium ions is further made smother. Thus, there is an advantage in that at the time of charging/discharging, reduction, etc. of the lithium metal occurs more uniformly, as well as an advantage in that irregular dendrite growth can be more effectively suppressed even in high current density.

That is, the method of manufacturing a composite anode for a lithium secondary battery according to the present invention can manufacture the composite anode for the lithium secondary battery such that the lithium metal or the lithium metal composite is evenly distributed and located using a simple pulse electrodepositing way while minimizing an amount of lithium used, and thus has an advantage of excellent safety as well as economical efficiency.

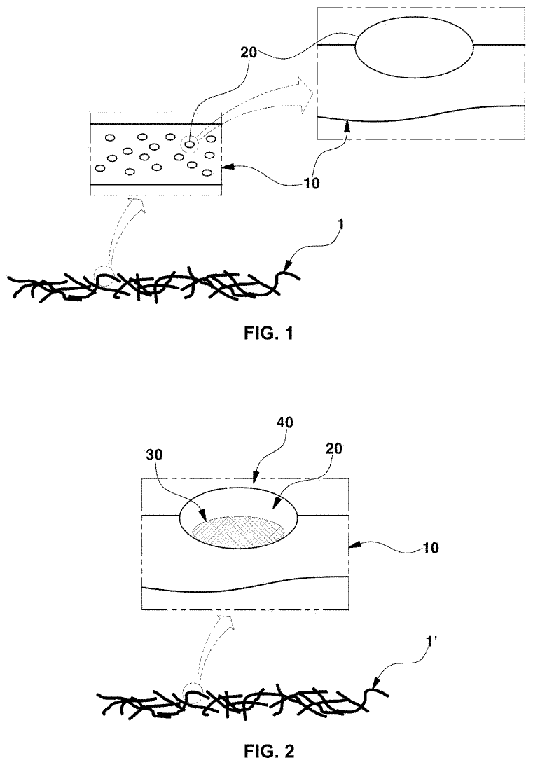

FIG. 1 is a sectional view and an enlarged view illustrating an exemplary composite anode for a lithium secondary battery in which a lithium metal is included according to the present invention. As shown in FIG. 1, a composite anode 1 for a lithium secondary battery according to an exemplary embodiment of the present invention may be manufactured by the above manufacturing method, and includes a porous conductor 10 and a lithium metal 20 that is evenly located on the porous conductor. The composite anode for a lithium secondary battery in which the lithium metal is included can include contents that substantially overlap with the above-mentioned method of manufacturing a composite anode for a lithium secondary battery, and description of the overlapped portion can be omitted.

A content of the lithium metal that is evenly located on the porous conductor may range from 0.05 wt % to 30 wt % on the basis of the entire composite anode of 100 wt %.

A size of the lithium metal distributed on the porous conductor may range from about 5 nm to about 100 nm, and preferably from about 10 nm to about 30 nm. When the size of the lithium metal deviates from the range and is too small, e.g., less than about 5 nm, there is a disadvantage in that a sufficient reaction area is not provided and lithium ions of a cathode can be completely consumed in an initial cell reaction due to an irreversible reaction. When the size of the lithium metal is too large, e.g., greater than about 100 nm, there is a disadvantage in that a single particle shape cannot be maintained and a current concentration phenomenon is caused by forming a cluster-like or irregular surface on which coarse particles are conglomerated.

Meanwhile, FIG. 2 is a sectional view and an enlarged view illustrating a composite anode for a lithium secondary battery in which a lithium metal composite is included according to the present invention. Referring to FIG. 2, a composite anode 1′ for a lithium secondary battery according to the present invention is manufactured by the above manufacturing method, and includes a porous conductor 10 and a lithium metal composite 40 that is evenly located on the porous conductor. Here, the lithium metal composite 40 is characterized by including a lithium metal 20 on a lithium alloy 30. The composite anode for a lithium secondary battery in which the lithium metal composite is included can include contents that substantially overlap with the above-mentioned method of manufacturing a composite anode for a lithium secondary battery, and description of the overlapped portion can be omitted.

A size of the lithium metal composite distributed on the porous conductor may range from about 10 μm to about 200 μm. When the size of the lithium metal composite deviates from the range and is too small, e.g., less than about 10 μm, there is a disadvantage in that the lithium metal composite fails to contain a sufficient amount of lithium and some lithium can be reduced on a copper current collector. When the size of the lithium metal composite is too large, e.g., greater than about 200 μm, there is a disadvantage in that a cathode layer becomes excessively thick and a weight energy density becomes low.

The composite anode for a lithium secondary battery according to the an exemplary embodiment of the present invention has an advantage in that dendrite growth of lithium during charging can be efficiently suppressed because the lithium metal or the lithium metal composite is uniformly located on the porous conductor in a specific size.

Further, the lithium secondary battery according to an exemplary embodiment of the present invention may include a cathode, an electrolyte membrane, and a composite anode for the lithium secondary battery according to an exemplary embodiment of the present invention, and particularly may be a battery in which a cathode current collector, a cathode, an electrolyte membrane, a composite anode, and an anode current collector are laminated in turn. A content substantially overlapping with the above-mentioned composite anode for a lithium secondary battery may be included, and description of the overlapping portion may be omitted.

The cathode current collector may be, for example, an aluminum thin plate.

The cathode may include a solid electrolyte and an active material that act as a cathode layer that can be used for a typical lithium secondary battery.

The active material may be an oxide active material or a sulfide active material. For example, the oxide active material may be a rock salt layered active material such as LiCoO₂, LiMnO₂, LiNiO₂, LiVO₂, and Li₁₊ₓNi_{1/3}Co_{1/3}Mn_{1/3}O₂, a spinel active material such as LiMn₂O₄ and Li(Ni_{0.5}Mn_{1.5})O₄, an inverse spinel active material such as LiNiVO₄ and LiCoVO₄, an olivine type active material such as LiFePO₄, LiMnPO₄, LiCoPO₄ and LiNiPO₄, a silicon containing active material such as Li₂FeSiO₄, and Li₂MnSiO₄, a rock salt layered active material such as LiNi_{0.8}Co_{(0.2-x)}AlxO₂(0<x<0.2) obtained by substituting a part of a transition metal with a different metal, a spinel active material such as Li₁₊ₓMn_{2-x-y}M_{y}O₄ (M is at least one of Al, Mg, Co, Fe, Ni, and Zn, and 0<x+y<2) obtained by substituting a part of a transition metal with a different metal, and lithium titanate such as Li₄Ti₅O₁₂. Further, the sulfide active material may be copper Chevrel, iron sulfide, cobalt sulfide, nickel sulfide, or the like.

The solid electrolyte is a component that takes charge of lithium ion conduction, and may be an oxide-based solid electrolyte or a sulfide-based solid electrolyte. However, the sulfide-based solid electrolyte having high lithium ion conductivity is preferably used.

The solid electrolyte may be a solid electrolyte based on Chemical Formula 1 below.

LₐM_{b}P_{c}SₐXₑ [Chemical Formula 1]

L is one or more elements selected from the group consisting of alkali metals, M is one or more elements selected from the group consisting of B, Al, Ga, In, Si, Ge, Sn, Pb, As, Sb, Bi, Ti, V, Mn, Fe, Co, Ni, Cu, Y, Zr, Nb, Mo, Tc, Ru, Rh, Pd, Ag, Hf, Ta, and W, X is one element selected from the group consisting of F, Cl, Br, I, and O, 0≤a≤12, 0≤b≤6, 0≤c≤6, 0≤d≤12, and 0≤e≤9.

More preferably, the solid electrolyte may include one or more selected from the group consisting of Li₆PS₅C₁, Li₂S—P₂S₅, Li₂S—P₂S₅—LiCl, Li₂S—P₂S₅—LiBr, Li₂S—P₂S₅—Li₂O, Li₂S—SiS₂, Li₂S—SiS₂—LiBr, Li₂S—SiS₂—LiCl, Li₂S—B₂S₃, Li₂S—P₂S₅—ZₘSₙ (here, m and n are positive numbers, and Z is one of Ge, Zn, and Ga), Li₂S—GeS₂, Li₂S—SiS₂-Li₃PO₄, Li₂S—SiS₂-LiₓMO_{y}. x and y are positive numbers, and M is one of P, Si, Ge, B, Al, Ga, and In), and Li₁₀GeP₂S₁₂.

Further, the cathode layer may further include a conductive material for improving electric conductivity. Preferably, the cathode layer may include carbon black, conductive graphite, ethylene black, graphene, or the like.

The anode current collector may be a metal thin film that includes a metal selected from the group consisting of copper (Cu), nickel (Ni), and a combination thereof.

Further, the lithium secondary battery according to the present invention may be joined with a fluid channel using, for instance, a gasket.

### EXAMPLE

Hereinafter, the present invention will be described in greater detail through the following examples. The following examples are merely examples for understanding of the present invention, and the scope of the present invention is not restricted thereby.

### Manufacturing Example 1: Manufacturing Composite Anode for Lithium Secondary Battery Including Lithium Metal Composite

An electrolyte for electrodepositing lithium metal particles on a porous conductor was produced by mixing 1 M of lithium bis(trifluoromethanesulfony)imide (LiTFSI) that is a lithium salt with N-butyl-N-methyl-pyrrolidiniumbis(trifluoromethanesulfonyl)imide (Py14TFSI) that is an ionic liquid and agitating the mixture at a temperature of 80° C. for 1 hour (S10). Since the ionic liquid consisting of ions has viscosity relatively higher than other organic solvents, propylene carbonate was mixed at a weight ratio of 20% of the electrolyte. A two-electrode electrolysis system was configured using a carbon fiber as a working electrode and a lithium ribbon as a counter electrode for the electrolyte. At this time, the working electrode and the counter electrode were disposed at an interval of 5 mm, and an area of the counter electrode was set to be sufficiently larger than that a reaction area of the working electrode (S20).

The lithium metal composite could control shapes of the lithium metal particles formed at a different pulse level as in Formula 1. When a high pulse level was applied by controlling an applied voltage to be high and a pulse time to be short, a particle size was small and the number of particles per unit area increased. By contrast, when a low pulse level was applied by controlling the applied voltage to be low and the pulse time to be long, this became a condition on which a rate of nucleation was lowered and a particle growth predominated, so that a composite was obtained in which the number of particles was reduced and coarse particles were distributed. The lithium metal composite was manufactured in which 24 to 29 lithium metal particles per unit area of 100 nm² were formed on a surface of a conductive structure by performing pulse electrodeposition such that the number of pulse frequencies became 1000 for a pulse time of 1000 ms by applying a pulse voltage of 1.5 V vs. Li reduction using the above properties (S30).

### Example 1: Manufacturing all-Solid-State Battery Including Composite Anode for Lithium Secondary Battery Including Lithium Metal Composite

Cathode slurry was manufactured by mixing a cathode active material (NCM711), a solid electrolyte (Li₆PS₅C₁), a conductive agent (super-C), and a rubber-based binder. A cathode electrode was manufactured by applying the slurry to an aluminum foil and then drying the slurry. The cathode electrode obtained from this was used as a cathode layer by punching it in a size of A solid electrolyte of 0.15 to 1.5 g was input as a solid electrolyte layer, and the lithium metal composite manufactured in Example 1 was input as an anode layer. These layers were molded under a pressure of 200 to 500 MPa, thereby manufacturing an all-solid-state battery.

### Comparative Example 1: Method of Manufacturing Lithium Foil Anode and all-Solid-State Battery

A lithium foil having a thickness of 200 μm and a copper current collector were punched in a size of Φ 13 and were stacked in turn, so that a lithium foil anode electrode was manufactured. Excepting using the lithium foil anode as an anode layer, an all-solid-state battery was manufactured using the same method as in Example 1.

### Comparative Example 2: Method of Manufacturing Lithium Powder Anode and all-Solid-State Battery

2 wt % to 15 wt % of polyvinylidene fluoride (PVDF) was mixed using N-methyl-2-pyrrolidone (NMP) as a solvent, and thereby a binder solution was manufactured. Lithium powder having a size of 10 μm to 30 μm was added and mixed by 85 wt % to 98 wt %, and then was applied to a copper current collector to dry the solvent. The lithium powder anode electrode was manufactured by punching the dried electrode in a size of Φ 13. Excluding using the lithium powder anode as an anode layer, an all-solid-state battery was manufactured using the same method as in Example 1.

### Experimental Example 1: Manufacturing Lithium Metal Composite and its Particle Size Control

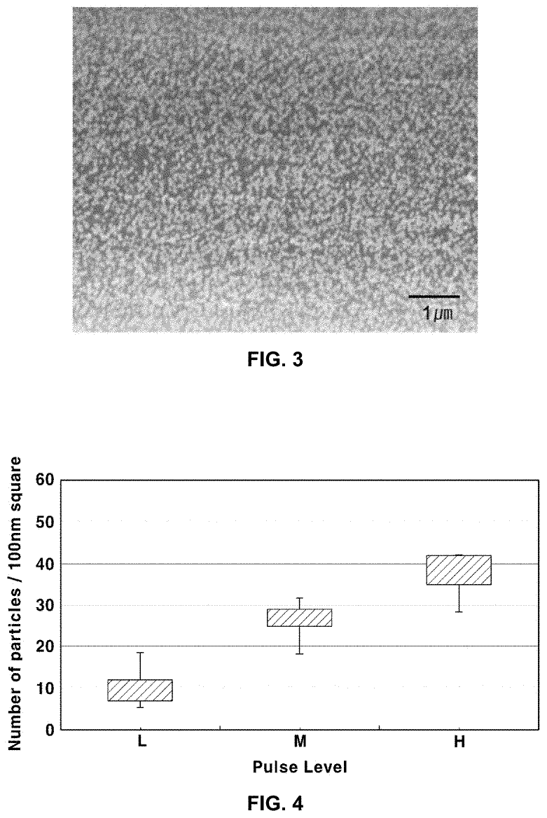

FIG. 3 shows an FE-SEM image of a surface of a composite anode for a lithium secondary battery (including a lithium metal composite) which is manufactured according to Manufacturing Example 1. As shown in to FIG. 3, it can be found that lithium metal particles having a size of 10 nm to 30 nm was uniformly distributed on a carbon fiber surface. The number and size of the lithium metal particles could be determined by controlling a pulse level. Since the pulse level was proportional to a pulse voltage V and was inversely proportional to a pulse time s, the pulse level could be determined as in Equation 1 below. For example, when an applied voltage was −4.5 V and the pulse time was 1000 ms, the pulse voltage was 1.5 V, and thus the pulse level was 15.

$$Pulse Level = \frac{Pulse Voltage ( V )}{Pulse Time ( s )} \times Pulse Frequency ( k ) \qquad [ Equation 1 ]$$

FIG. 4 is a graph illustrating a result of controlling lithium particles according to a pulse level of the composite anode for a lithium secondary battery (including a lithium metal composite) which is manufactured according to Manufacturing Example 1. As shown in FIG. 4, when the pulse level was a low level of 1 to 9, it could be found that the number of produced lithium particles was 7 to 12 per unit area of 100 nm² which was relatively small, and growth of the particles was dominant so that coarse particles were formed. When the pulse level was a high level of 15 to 20, it could be found that 35 to 42 lithium particles per unit area were produced.

### Experimental Example 2: Comparison Between Charging/Discharging Characteristics of all-Solid-State Battery

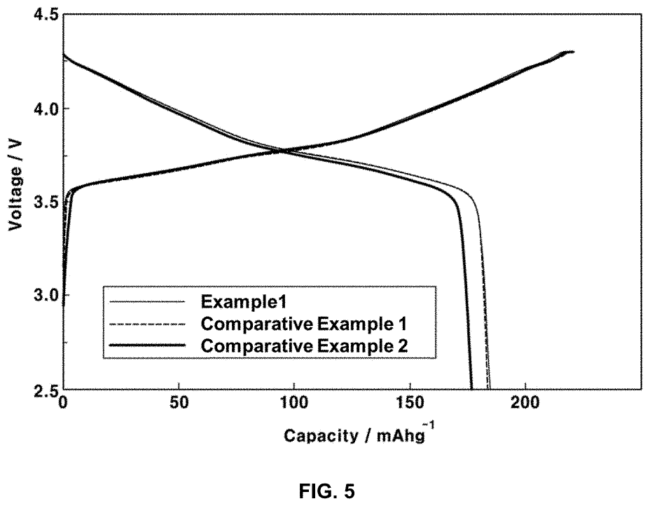

After all-solid-state batteries were manufactured according to Example 1, Comparative Example 1, and Comparative Example 2, a result of evaluating charging/discharging characteristics by carrying out charging and discharging at a cell temperature of 60° C., in a voltage range of 3.0 to 4.3 V, and at a speed of 0.1 C was represented in Tables 1 and 2 and FIG. 5.

To be specific, FIG. 5 is a charging and discharging graph of an all-solid-state battery according to Example 1, Comparative Example 1, and Comparative Example 2.

TABLE 1

| | Weight of lithium | Weight percent (%) of |
|---|---|---|
| | metal (mg) | lithium inside anode |
| Example 1 | 0.056 | 0.06 |
| Comparative | 12.6 | 100 |
| Example 1 | | |
| Comparative | 2.5 | 95 |
| Example 2 | | |

TABLE 2

| | Discharging | Coulomb |
|---|---|---|
| | capacity (mAh/g) | efficiency (%) |
| Example 1 | 184.4 | 84.6 |
| Comparative | 183.7 | 83.4 |
| Example 1 | | |
| Comparative | 176.4 | 80.2 |
| Example 2 | | |

As shown in Table 1, Table 2, and FIG. 5, when a lithium anode composite and a lithium foil were used as anode layers, initial capacity was about 183 mAh/g, which represented the same performance. In a case of the all-solid-state battery in which the lithium powder anode was used as the anode layer, it could be checked that discharging capacity was 176 mAh/g and was relatively low. At this time, since coulomb efficiency was 84.6%, 83.4%, and 80.2%, and was lowest in the lithium powder anode formed of many grain boundaries and a binder, and a conductive structure secured a stable electron transfer path, it could be found that the conductive structure was further improved in efficiency than the lithium foil by about 1%.

### Experimental Example 2: Cycle Lifespan Evaluation of all-Solid-State Battery

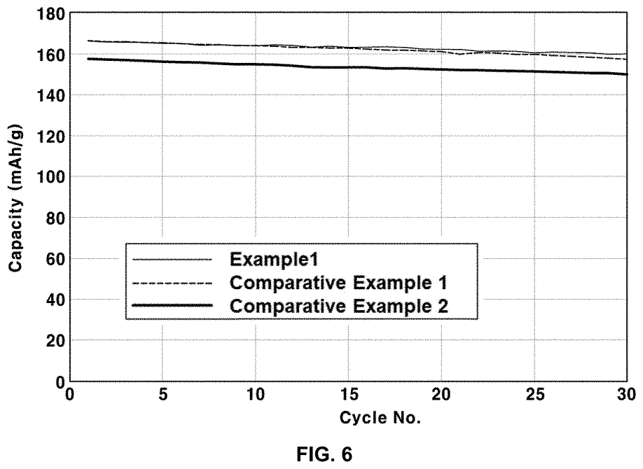

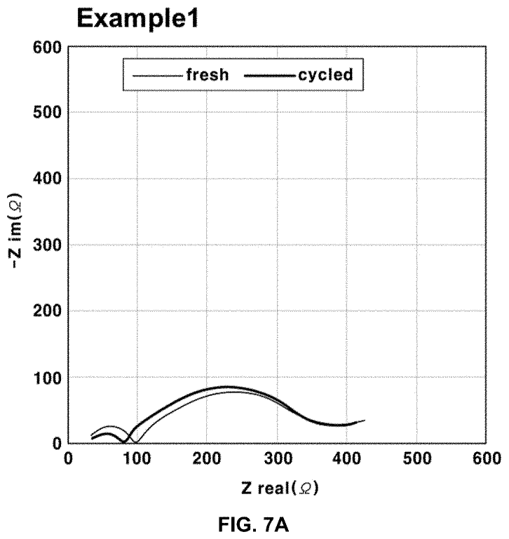

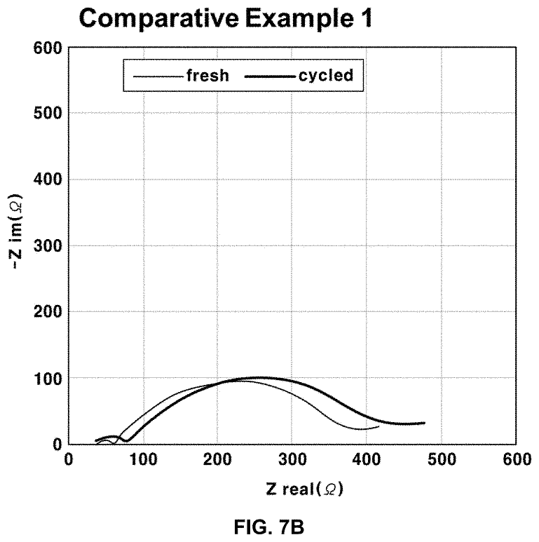

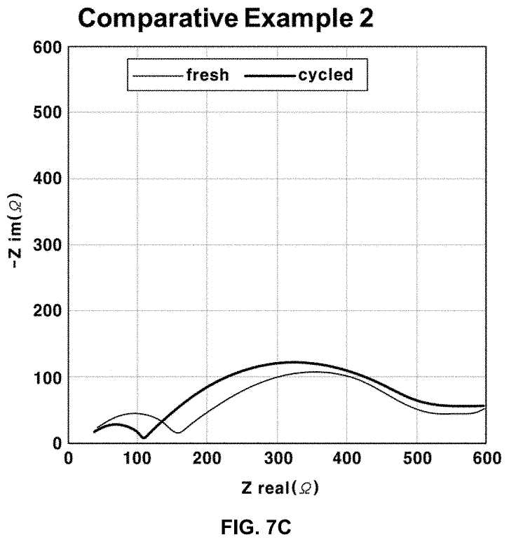

After all-solid-state batteries were manufactured according to Example 1, Comparative Example 1, and Comparative Example 2, a result of evaluating cycle characteristics by carrying out charging and discharging at a cell temperature of 60° C., in a voltage range of 3.0 to 4.3 V, and at a C-rate of 0.5 C was represented in Table 3 and FIG. 6.

FIG. 6 is a graph showing results of evaluating cycle characteristics of an all-solid-state battery according to Example 1, Comparative Example 1, and Comparative Example 2.

TABLE 3

| | Discharging | Capacity |
|---|---|---|
| | capacity | maintenance |
| | (mAh/g) | rate (%) |
| Example 1 | 159.8 | 96.3 |
| Comparative | 157.3 | 94.5 |
| Example 1 | | |
| Comparative | 150 | 95.4 |
| Example 2 | | |

As shown in FIG. 6 and Table 3, it could be found that residual capacities after charging and discharging were preformed 30 times were 159.8 mAh/g, 157.3 mAh/g, and 150.0 mAh/g, and capacity maintenance rates based on a first cycle were 96.3%, 94.5%, and 95.4%. In the case of Example 1, it could be checked that a discharging capacity and a capacity maintenance rate were most excellent, and it could be predicted that Comparative Example 1 showed a lowest capacity maintenance rate and that the residual capacity was considerably reduced as the cycle proceeded, and it could be checked that Comparative Example 2 had a higher capacity maintenance rate than Comparative Example 1 but had a relatively lower discharging capacity than Comparative Example 1.

### Experimental Example 3: Impedance Evaluation

After all-solid-state batteries were manufactured according to Example 1, Comparative Example 1, and Comparative Example 2, results of evaluating impedance measured by applying an amplitude of 10 mv in a frequency range of 1 mhz to 0.1 hz were shown in FIGS. 7A to 7C.

FIGS. 7A to 7C are graphs illustrating results of evaluating cycle characteristics of the all-solid-state battery according to Example 1 (FIG. 7A), Comparative Example 1 (FIG. 7B), and Comparative Example 2 (FIG. 7C).

As shown in FIGS. 7A to 7C, initial cell resistance of Example 1 was similar to that of Comparative Example 1, and the initial cell resistance of Comparative Example 2 was increased by about 30%. It could be checked that this had a similar tendency on the same reason as in Example 1. In the case of Example 1, a change of the cell resistance after the cycle was hardly shown, and in the case of Comparative Examples 1 and 2, it could be found that resistance of all of the cells was increased, and a resistance element was changed. Unlike Comparative Examples 1 and 2, it could be found in Example 1 that a stable redox reaction of lithium was maintained while charging/discharging was proceeding.

### DESCRIPTION OF REFERENCE NUMERALS

1, 1′: composite anode for a lithium secondary battery
10: porous conductor
20: lithium metal
30: lithium alloy
40: lithium metal composite

What is claimed is:

1. A method of manufacturing a composite anode for a lithium secondary battery, comprising:
preparing an electrolyte comprising a lithium salt and a solvent;
disposing a working electrode and a counter electrode in the electrolyte, wherein the working electrode comprises a porous conductor and the counter electrode comprises a lithium metal; and
applying a voltage or a current through a power supply connected to the working electrode and counter electrodes to perform pulse electrodeposition of the lithium metal on the porous conductor.

2. The method of manufacturing a composite anode for a lithium secondary battery according to claim 1, wherein the lithium salt comprises one or more selected from the group consisting of LiPF₆, LiBF₄, LiTFSI, LiClO₄, LiTf, LiAsF₆, LiFSA, LiBOB, LiDFOB, LiBETI, LiDCTA, LiTDI, LiPDI, LiI, LiF, and LiCl.

3. The method of manufacturing a composite anode for a lithium secondary battery according to claim 1, wherein the solvent comprises one or more selected from an organic solvent and an ionic liquid.

4. The method of manufacturing a composite anode for a lithium secondary battery according to claim 1, wherein a concentration of the lithium salt in the electrolyte is from about 0.05 M to about 2 M.

5. The method of manufacturing a composite anode for a lithium secondary battery according to claim 1, wherein the porous conductor comprises one or more selected from the group consisting of a carbon nanotube, a carbon felt, carbon paper, and a carbon fiber.

6. The method of manufacturing a composite anode for a lithium secondary battery according to claim 1, wherein, when the pulse electrodeposition is performed, the voltage is applied by a greater value than an absolute value of a lithium reduction potential by about 1.0 V to 2 V.

7. The method of manufacturing a composite anode for a lithium secondary battery according to claim 1, wherein, when the pulse electrodeposition is performed, the number of pulse frequencies ranges from about 50 to about 2000.

8. The method of manufacturing a composite anode for a lithium secondary battery according to claim 1, wherein, when the pulse electrodeposition is performed, a pulse time ranges from about 10 ms to about 1000 ms.

9. The method of manufacturing a composite anode for a lithium secondary battery according to claim 1, wherein, when the pulse electrodeposition is performed, a working temperature is equal to or less than about 200° C.

10. The method of manufacturing a composite anode for a lithium secondary battery according to claim 1, further comprising plating a lithium alloy on the porous conductor.

11. The method of manufacturing a composite anode for a lithium secondary battery according to claim 10, wherein the lithium alloy comprises i) lithium (Li), and ii) one or more selected from the group consisting of gold (Au), silver (Ag), tin (Sn), copper (Cu), aluminum (Al), magnesium (Mg), nickel (Ni), titanium (Ti), silicon (Si), and antimony (Sb).

12. The method of manufacturing a composite anode for a lithium secondary battery according to claim 10, wherein, when the pulse electrodeposition is performed, the lithium metal is pulse-electrodeposited on the lithium alloy.

13. The method of manufacturing a composite anode for a lithium secondary battery according to claim 1, further comprising surface-modifying the pulse-electrodeposited result.

14. A composite anode for a lithium secondary battery comprises:
a porous conductor; and
a lithium metal located uniformly on the porous conductor.

15. The composite anode for a lithium secondary battery according to claim 14, wherein a contend of the lithium metal is from about 0.05 wt % to about 30 wt % on the basis of 100 wt % of the entire composite anode.

16. The composite anode for a lithium secondary battery according to claim 14, wherein the lithium metal has a size of about 5 nm to 100 nm.

17. A composite anode for a lithium secondary battery comprising:
a porous conductor; and
a lithium metal composite located uniformly on the porous conductor,
wherein the lithium metal composite comprises a lithium metal on a lithium alloy.

18. The composite anode for a lithium secondary battery according to claim 17, wherein the lithium alloy comprises i) lithium (Li), and ii) one or more selected from the group consisting of gold (Au), silver (Ag), tin (Sn), copper (Cu), aluminum (Al), magnesium (Mg), nickel (Ni), titanium (Ti), silicon (Si), and antimony (Sb).

19. The composite anode for a lithium secondary battery according to claim 17, wherein the lithium metal composite has a size of about 10 μm to 200 μm.
